(19) United States
(12) Patent Application Publication
(10) Pub. No.: US 2007/0152590 A1
(43) Pub. Date: Jul. 5, 2007

(54) Plasma display panel

(76) Inventor: Jung-Tae Park, Suwon-si (KR)

Correspondence Address: CHRISTIE, PARKER & HALE, LLP, PO BOX 7068, PASADENA, CA, 91109-7068, US

(21) Appl. No.: 11/601,256

(22) Filed: Nov. 17, 2006

(30) Foreign Application Priority Data
Dec. 30, 2005 (KR) 10-2005-0135862

(51) Int. Cl. H01J 17/49

(52) U.S. Cl. 313/586; 313/582

(57) ABSTRACT

A plasma display panel is provided having shield walls between discharge cells to prevent luminous interference between adjacent discharge cells. The plasma display panel includes a first substrate and a second substrate facing each other. Barrier ribs are disposed to define a plurality of discharge cells between the first substrate and the second substrate. Pairs of sustain electrodes extend in a direction on the first substrate and cross the discharge cells. Address electrodes cross the pairs of sustain electrodes. A first dielectric layer covers the pairs of sustain electrodes. A second dielectric layer covers the address electrodes. Phosphor layers are formed in the discharge cells. Shield walls are disposed between the first substrate and the second substrate to surround each of the discharge cells.

### CROSS-REFERENCE TO RELATED PATENT APPLICATION

This application claims priority to and the benefit of Korean Patent Application No.10-2005-0135862, filed on Dec. 30, 2005, in the Korean Intellectual Property Office, the entire content of which is incorporated herein by reference.

### BACKGROUND OF THE INVENTION

1. Field of the Invention

The present invention relates to a plasma display panel (PDP), and more particularly, to a PDP that prevents luminous interference between adjacent discharge cells.

2. Description of the Related Art

PDPs, which have replaced conventional cathode ray tube (CRT) display devices, display desired images using visible rays generated by sealing discharge gas and applying a discharge voltage between two substrates on which a plurality of electrodes are formed to generate vacuum ultraviolet rays, and exciting phosphors on which the vacuum ultraviolet rays are formed in a predetermined pattern.

FIG. 1 is an exploded perspective view of a conventional PDP.

Referring to FIG. 1, a typical alternate current (AC) type PDP 10 includes an upper plate 50 on which images are displayed and a lower plate 60 coupled parallel to the upper plate 50. Pairs of sustain electrodes 12, each pair including an X electrode 31 and a Y electrode 32, are formed on a front substrate 11 of the upper plate 50. Address electrodes 22 crossing the X and Y electrodes 31, 32 of the front substrate 11 are disposed on a rear substrate 21 of the lower plate 60 facing a surface of the front substrate 11 where the pairs of sustain electrodes 12 are disposed.

A first dielectric layer 15 that buries the pairs of sustain electrodes 12 and a second dielectric layer 25 that buries the address electrodes 22 are formed on the front substrate 11 and the rear substrate 21, respectively. A protective layer 16 usually formed of MgO is disposed in a rear surface of the first dielectric layer 15. Barrier ribs 30 that maintain a discharge distance and prevent electrical and optical cross talk between discharge cells are formed on the front surface of the second dielectric layer 25.

Red, green, and blue phosphor layers 26 are coated on both sides of the barrier ribs 30 and on the front surface of the second dielectric layer 25 where the barrier ribs 30 are not formed.

The X electrodes 31 and the Y electrodes 32 include transparent electrodes 31a, 32a and bus electrodes 31b, 32b, respectively. A space formed by a pair of the X electrodes 31 and the Y electrodes 32, and the address electrodes 22 crossing the X and Y electrodes 31, 32, is a unit discharge cell 70 which forms a discharge unit. The transparent electrodes 31a, 32a are formed of a conductive transparent material that can generate a discharge and does not interrupt light emitted from the phosphor layers 26 toward the front substrate 11. The transparent material can be indium tin oxide (ITO).

The discharge generated in each of the discharge cells 70 and the light emitted from the phosphor layers 26 can affect luminescence of adjacent discharge cells 70, which may cause luminous interference between the adjacent discharge cells 70. A discharge generated in luminous cells can affect non-luminous cells.

Further, the luminous interference between the adjacent discharge cells 70 can deteriorate the degree of definition of an image displayed by the discharge generated in each of the discharge cells 70.

### SUMMARY OF THE INVENTION

One embodiment of the present invention provides a PDP that forms shield films between discharge cells in order to prevent luminous interference between adjacent discharge cells.

According to one aspect of the present invention, a PDP includes a first substrate and a second substrate facing each other. Barrier ribs are disposed between the first substrate and the second substrate defining a plurality of discharge cells. Pairs of sustain electrodes extend in a direction on the first substrate and cross the discharge cells. Address electrodes cross the pairs of sustain electrodes. A first dielectric layer covers the pairs of sustain electrodes. A second dielectric layer covers the address electrodes. Phosphor layers are formed in the discharge cells. Finally, shield walls are disposed between the first substrate and the second substrate to surround each of the discharge cells.

According to another aspect of the present invention, a PDP includes a first substrate and a second substrate facing each other. Barrier ribs are disposed defining a plurality of discharge cells between the first substrate and the second substrate. Pairs of sustain electrodes extend in a direction on the first substrate and cross the discharge cells. Address electrodes cross the pairs of sustain electrodes. A first dielectric layer covers the pairs of sustain electrodes. A second dielectric layer covers the address electrodes. Phosphor layers are formed in the discharge cells so as to provide pixels, each of the pixels having a red discharge cell, a green discharge cell, and a blue discharge cell adjacent to each other. Finally, shield walls are disposed between the first substrate and the second substrate to surround each pixel.

In one embodiment, the shield walls may be disposed between the first substrate and the barrier ribs.

In another embodiment, the shield walls may be formed on the same layer as the first dielectric layer.

In another embodiment, the PDP may further include a protective layer covering a surface of the first dielectric layer to protect the first dielectric layer with the protective layer facing the second substrate. In addition, the shield walls are formed in a layer encompassing both the first dielectric layer and the protective layer.

In another embodiment, the shield walls may be black.

In another embodiment, the shield walls may be formed by the first dielectric layer material with added black pigment.

In another embodiment, the shield walls may have a reflexibility of less than 60%.

### BRIEF DESCRIPTION OF THE DRAWINGS

FIG. 1 is a partially exploded perspective view of a conventional PDP.

FIG. 2 is a partially exploded perspective view of a PDP according to an embodiment of the present invention.

FIG. 3 is a cross-sectional view of the PDP of FIG. 2 taken along a line III-III of FIG.2.

FIG. 4 is a plan view illustrating a pair of sustain electrodes and a shield wall disposed on a second substrate of the PDP of FIG. 2.

FIG. 5 is cross-sectional view of the PDP according to a modified embodiment of FIG. 3.

FIG. 6 is a partial exploded perspective view illustrating a PDP according to another embodiment of the present invention.

FIG. 7 is a cross-sectional view of the PDP of FIG. 6 taken along a line VI-VI of FIG. 6.

FIG. 8 is a plan view illustrating a pair of sustain electrodes and a shield wall disposed on a second substrate in the PDP of FIG. 6.

FIG. 9 is a cross-sectional view of the PDP according to a modified embodiment of FIG. 7.

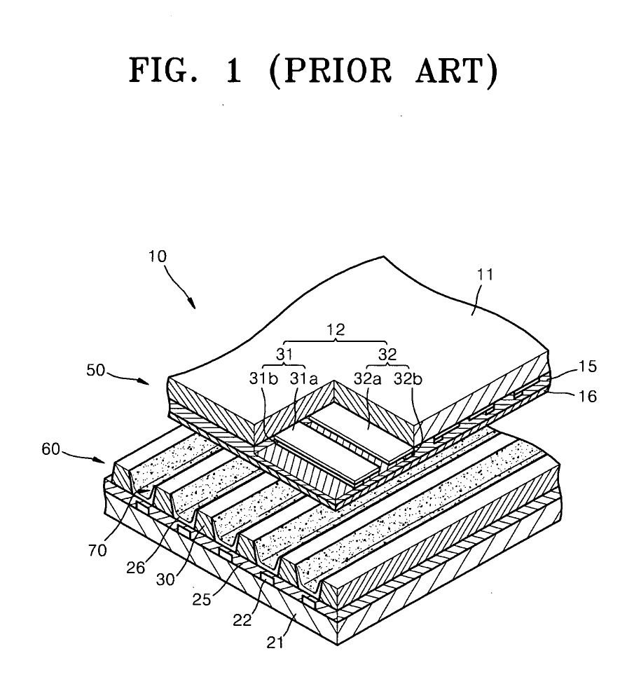

### DETAILED DESCRIPTION

The present invention will now be described more fully with reference to the accompanying drawings, in which exemplary embodiments of the invention are shown.

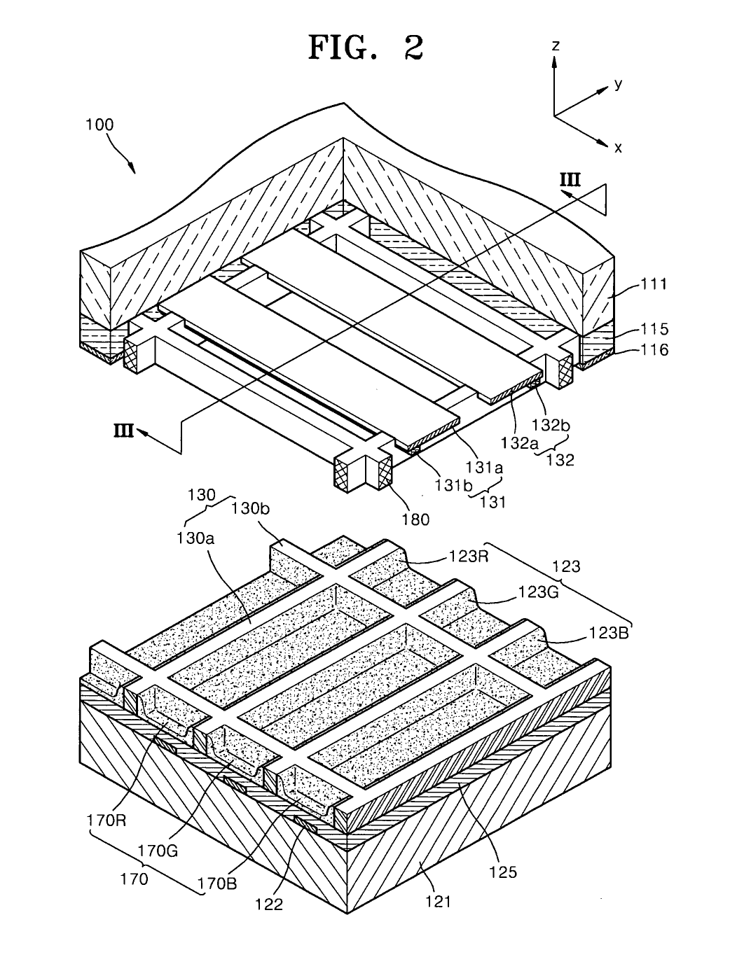

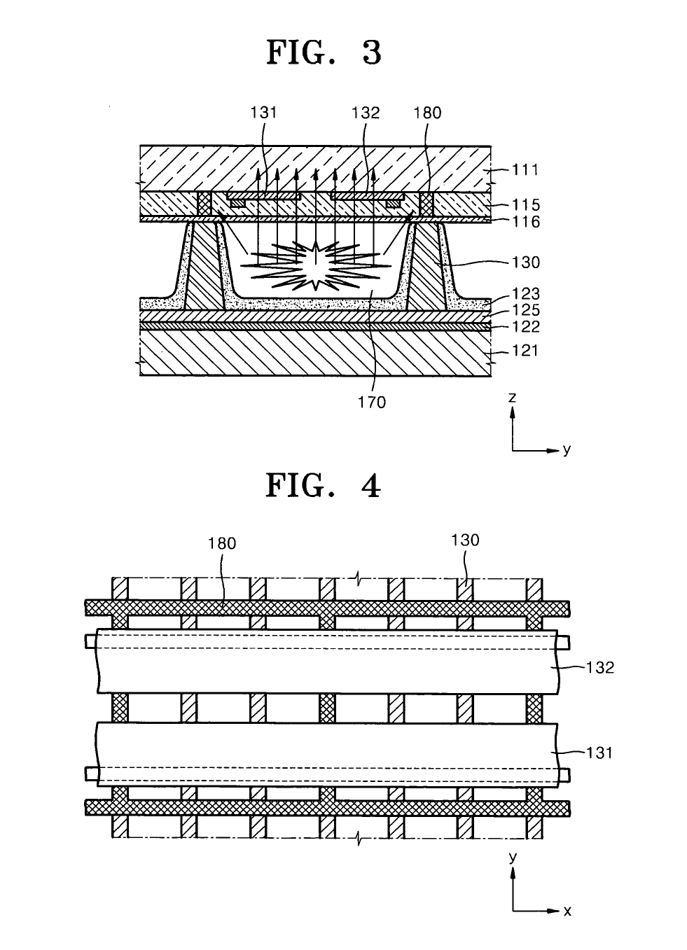

FIG. 2 is a partially exploded perspective view illustrating a PDP 100 according to an embodiment of the present invention. FIG. 3 is a cross-sectional view of the PDP of FIG. 2 taken along a line III-III of FIG. 2. FIG. 4 is a plan view illustrating a pair of sustain electrodes 131, 132 and a shield wall 180 disposed on a second substrate 121 of the PDP of FIG. 2.

Referring to FIGS. 2 through 4, the alternate current type PDP 100 includes a first substrate 111, the second substrate 121, pairs of sustain electrodes 131, 132, address electrodes 122, barrier ribs 130 that include barrier rib components 130a, 130b, a protective layer 116, phosphor layers 123, a first dielectric layer 115, a second dielectric layer 125, a discharge gas (not shown), and the shield walls 180. The phosphor layers 123 include phosphor layers 123R, 123G, 123B.

The first substrate 111 and the second substrate 121 are spaced apart from each other by a predetermined gap, and define a discharge space where a discharge is generated therebetween. The first substrate 111 and the second substrate 121 may be formed of glass having excellent transmittance of visible rays. However, the first substrate 111 and/or the second substrate 121 can be colored in order to increase the bright room contrast.

The barrier ribs 130 are disposed between the first substrate 111 and the second substrate 121. The barrier ribs 130 can be disposed on the second dielectric layer 125 according to a conventional manufacturing process. The barrier ribs 130 define the discharge space into a plurality of discharge cells 170, which include red discharge cells 170R, green discharge cells 170G, and blue discharge cells 170B, and prevent optical and electrical cross-talk between the discharge cells 170R, 170G, 170B. Referring to FIG. 2, the barrier ribs 130 define the discharge cells 170R, 170G, 170B having rectangular cross-sections in the shape of a matrix, but the present invention is not limited thereto. That is, the barrier ribs 130 may define the discharge cells 170R, 170G, 170B having polygonal cross-sections, such as triangular or pentagonal cross-sections, circular or oval cross-sections, or open type such as a stripe, etc. Also, the barrier ribs 130 can define the discharge cells 170R, 170G, 170B in the shape of a waffle or delta.

The pairs of sustain electrodes 131, 132 are disposed on the first substrate 111 facing the second substrate 121. Each of the pairs of sustain electrodes 131, 132 is a pair of sustain electrodes 131, 132 formed on a rear surface of the first substrate 111 to generate a sustain discharge. The pairs of sustain electrodes 131, 132 are arranged parallel to each other on the first substrate 111 by a predetermined distance.

Of the pairs of sustain electrodes 131, 132, X electrodes 131 serve as common electrodes and Y electrodes 132 serve as scan electrodes. In the present embodiment, the pairs of sustain electrodes 131, 132 are disposed on the first substrate 111, but the present invention is not limited thereto. For example, the pairs of sustain electrodes 131, 132 can be spaced apart from each other by a predetermined gap in a direction from the first substrate 111 to the second substrate 121.

The sustain electrodes 131, 132 include transparent electrodes 131a, 132a and bus electrodes 131b, 132b, respectively. The transparent electrodes 131a, 132a are formed of a transparent and conductive material that can generate a discharge and does not interrupt light emitted from the phosphor layers 123 (123R, 123G, 123B) toward the first substrate 111. The transparent and conductive material is ITO.

However, the transparent electrodes 131a, 132a formed of ITO have a strong resistance, significant amount of driving power consumption and a slow response speed due to a large voltage drop in a length direction. To address these problems, the bus electrodes 131b, 132b formed of a metal material and having a narrow width are disposed on the transparent electrodes 131a, 132a. The bus electrodes 131b, 132b can have a single-layer structure using metal such as Ag, Al, or Cu, and have a multi-layer structure such as Cr/Al/Cr, etc. The transparent electrodes 131a, 132a and bus electrodes 131b, 132b can be formed using techniques such as photo-etching, photolithography, or the like.

With regard to the shape and arrangement of the sustain electrodes 131, 132, the bus electrodes 131b, 132b are spaced apart from each other by a predetermined gap in the discharge cells 170R, 170G, 170B, and extend to cross the discharge cells 170R, 170G, 170B. As described above, the transparent electrodes 131a, 132a are electrically connected to each of the bus electrodes 131b, 132b. The tetragonal transparent electrodes 131a, 132a are discontinuously arranged in each of the discharge cells 170R, 170G,170B. One pair of ends of the transparent electrodes 131a, 132a are connected to the bus electrodes 131b, 132b, and the other pair of ends of the transparent electrodes 131a, 132a are disposed to face the center of each of the discharge cells 170R, 170G, 170B.

The first dielectric layer 115 is formed on the first substrate 111 to bury the pairs of sustain electrodes 131, 132. The first dielectric layer 115 prevents direct conduction between adjacent sustain electrodes 131, 132, and prevents the sustain electrodes 131, 132 from being damaged due to direct collisions of charge particles or electrons with the sustain electrodes 131, 132. Also, the first dielectric layer 115 induces charges. The first dielectric layer 115 can be formed of PbO, B₂O₃, SiO₂, etc.

Also, the PDP 100 may further include the protective layer 116 covering the first dielectric layer 115. The protective layer 116 prevents the first dielectric layer 115 from being damaged due to direct collisions of charge particles and electrons with the first dielectric layer 115 during the discharge.

Also, the protective layer 116 emits a large amount of secondary electrons during the discharge to facilitate a plasma discharge. The protective layer 116 is formed of a material having a high coefficient of secondary electron emission and high transmission rate of visible rays. The protective layer 116 is formed using techniques such as sputtering, electronic beam deposition, or the like, after the first dielectric layer 115 is formed.

The address electrodes 122 are disposed on the second substrate 121 facing the first substrate 111. The address electrodes 122 extend to cross the sustain electrodes 131, 132 across the discharge cells 170R, 170G, 170B.

The address electrodes 122 generate an address discharge that facilitates a sustain discharge between the sustain electrodes 131, 132. More specifically, the address electrodes 122 reduce the voltage for generating the sustain discharge. The address discharge is generated between the Y electrodes 132 and the address electrodes 122. When the address discharge is completed, wall charges are accumulated on the sustain electrodes 131, 132, which facilitates the sustain discharge between the X electrodes 131 and the Y electrodes 132.

Spaces formed by a pair of the sustain electrodes 131, 132, and the address electrodes 122 that cross the sustain electrodes 131, 132, form the unit discharge cells 170R, 170G, 170B.

The second dielectric layer 125 is formed on the second substrate 121 to bury the address electrodes 122. The second dielectric layer 125 is formed of a dielectric substance capable of preventing the address electrodes 122 from being damaged due to collisions of charge particles or electrons with the address electrodes 122 and inducing charges. The dielectric substance may be formed of materials such as PbO, B₂O₃, SiO₂, or the like.

The phosphor layers 123R, 123G, 123B are disposed in both sides of the barrier ribs 130 formed on the second dielectric layer 125 and in the whole surface of the second dielectric layer 125 where the barrier ribs 130 are not formed. The phosphor layers 123R, 123G, 123B have a component generating visible light with ultraviolet rays. That is, a phosphor layer formed in a red light-emitting discharge cell 170R has a phosphor such as Y(V,P)O₄:Eu, a phosphor layer formed in a green light-emitting discharge cell 170G has a phosphor such as Zn₂SiO₄:Mn, YBO₃:Tb, and a phosphor layer formed in a blue light-emitting discharge cell 170B has a phosphor such as BAM:Eu.

A discharge gas in which Ne gas and Xe gas are mixed is filled in the discharge cells 170R, 170G, 170B. When the discharge gas is filled, the first substrate 111 and the second substrate 121 are coupled to each other using a sealing member such as frit glass formed on edges of the first and second substrates 111, 121.

An energy level of the discharge gas excited by the sustain discharge is reduced, thereby discharging ultraviolet rays. The ultraviolet rays excite the phosphor layers 123 coated in the discharge cells 170R, 170G, 170B, such that an energy level of the excited phosphor layers 123 is reduced to discharge visible rays which transmit through the first dielectric layer 115 and the first substrate 111 and form an image recognized by a user.

The shield walls 180 are disposed between the first substrate 111 and the second substrate 121 to surround each of the discharge cells 170R, 170G, 170B in order to prevent luminous interference between the adjacent discharge cells 170R, 170G, 170B. The shield walls 180 can be disposed between the first substrate 111 and the barrier ribs 130, and may be formed on the same layer as the first dielectric layer 115.

Although not shown in FIG. 2, the shield walls 180 can be formed on the same layer as a layer formed by the first dielectric layer 115 and the protective layer 116, thereby more effectively preventing luminous interference between the adjacent discharge cells 170R, 170G, 170B.

The shield walls 180 effectively prevent luminous interference between the adjacent discharge cells 170R, 170G, 170B, and may be black in order to increase the bright room contrast. To this end, the shield walls 180 can be formed by adding a black pigment to the same material as that of the first dielectric layer 115. In this case, the shield walls 180 may have reflexibility less than 60%.

In another embodiment of the present invention, the shield walls 180 effectively prevent luminous interference between the adjacent discharge cells 170R, 170G, 170B, and can have a bright color in order to increase the bright room contrast. To this end, the shield walls 180 can be formed of a material having high reflexibility.

The PDP 100 having the shield walls 180 divides luminous cells and non-luminous cells to prevent interference between luminous cells and non-luminous cells, and diffuses visible rays of luminous cells to prevent visible rays from moving to adjacent cells. To this end, the shield walls 180 may shield all the surroundings of luminous cells.

Referring to FIGS. 2 through 4, the discharge cells 170R, 170G, 170B are disposed to be adjacent to each other to form a pixel using visible rays radiated from each of the phosphor layers 123R, 123G, 123B. The shield walls 180 are disposed to surround each of the discharge cells 170R, 170G, 170B by pixels.

That is, luminous pixels and non-luminous pixels are divided by pixels to prevent interference therebetween, and visible rays of luminous pixels are diffused to prevent them from moving to adjacent non-luminous pixels. To this end, the shield walls 180 may shield all the surroundings of the discharge cells 170R, 170G, 170B that together form a pixel.

The shield walls 180 are formed surrounding each pixel. Each pixel includes discharge cells 170R, 170G, 170B. Thus, the shield walls 180 surround each set of discharge cells 170R, 170G, 170B. Forming the shield walls 180 to surround each pixel rather than surround each discharge cell reduces the number of the shield walls 180 required.

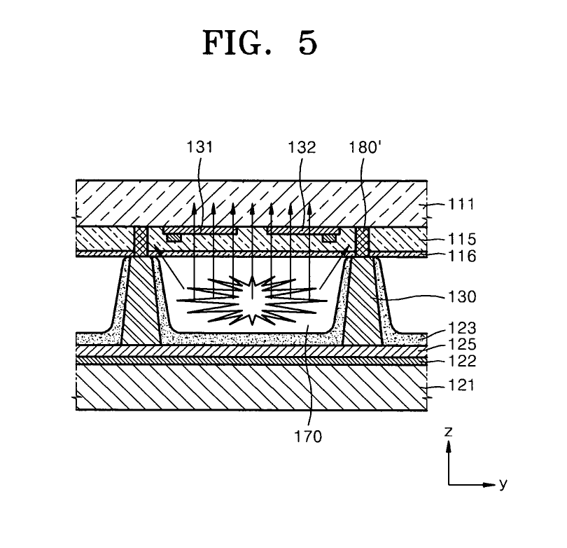

FIG. 5 is cross-sectional view of the PDP according to a modified embodiment of FIG. 3. As shown in FIG. 5, shield walls 180′ may be formed in a layer encompassing both the first dielectric layer 115 and the protective layer 116.

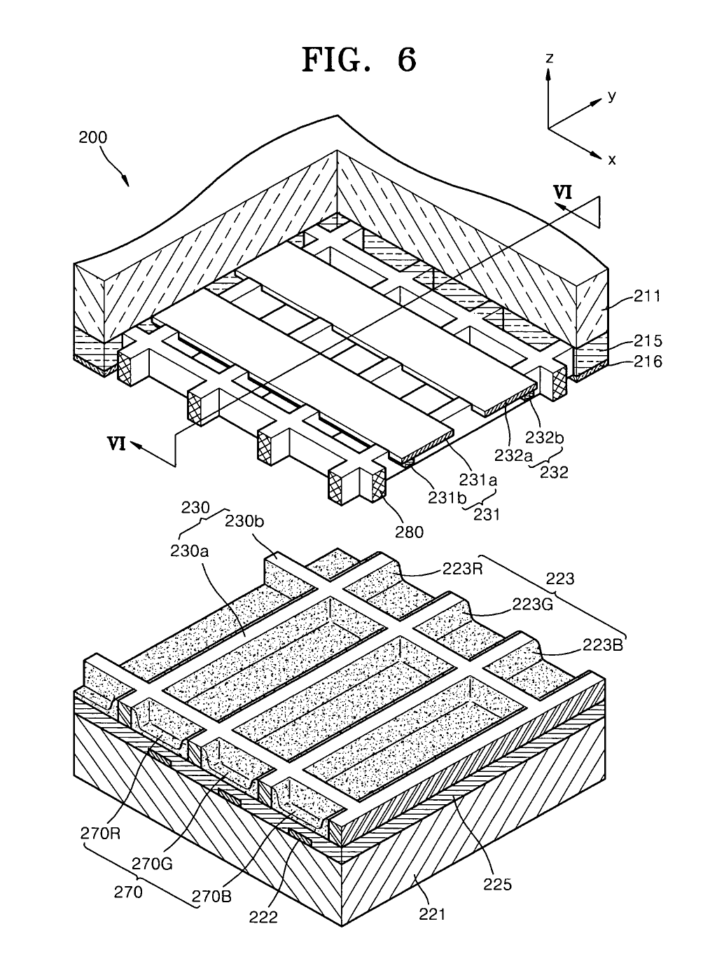

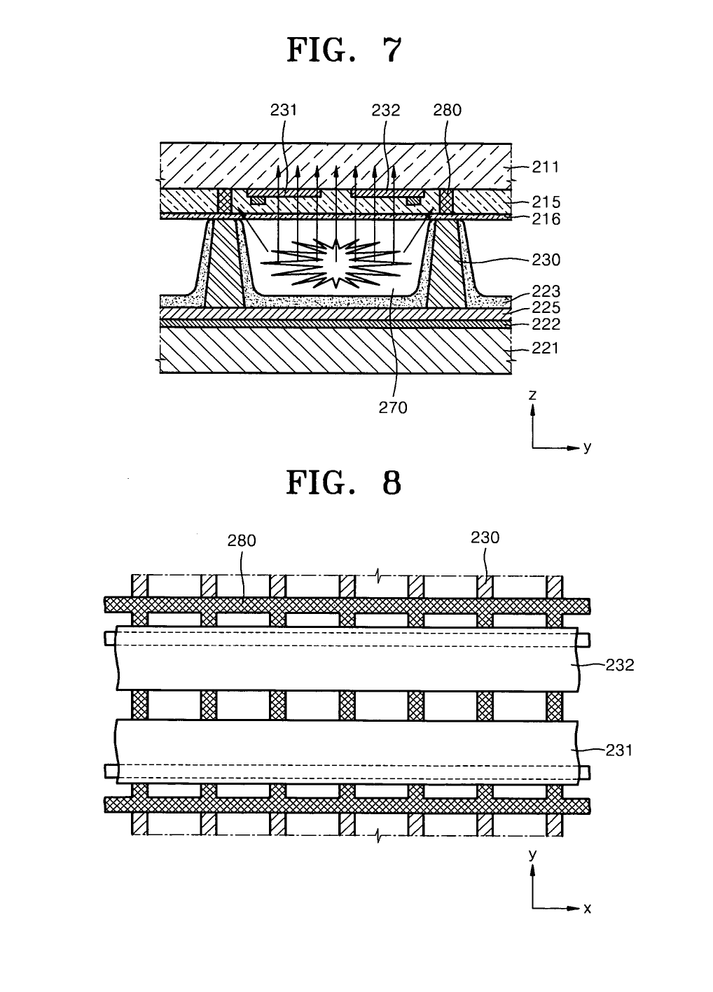

FIG. 6 is a partial exploded perspective view illustrating a PDP 200 according to another embodiment of the present invention. FIG. 7 is a cross-sectional view of the PDP of FIG. 6 taken along a line VI-VI of FIG. 6. FIG. 8 is a plan view illustrating a pair of sustain electrodes 231, 232 and a shield wall 280 disposed on a second substrate in the PDP of FIG. 6.

Referring to FIGS. 6 through 8, the alternate current type PDP 200 includes a first substrate 211, a second substrate 221, the pairs of sustain electrodes 231, 232, address electrodes 222, barrier ribs 230 that include barrier rib components 230a and 230b, a protective layer 216, phosphor layers 223, a first dielectric layer 215, a second dielectric layer 225, a discharge gas (not shown), and shield walls 280. The barrier ribs 230 define the discharge space into a plurality of discharge cells 270 (270R, 270G, 270B), and prevent optical and electrical cross-talk between the discharge cells 270R, 270G, 270B. The sustain electrodes 231, 232 include transparent electrodes 231a, 232a and bus electrodes 231b, 232b, respectively. The phosphor layers 223 include phosphor layers 223R, 223G, 223B.

In an embodiment, the shield walls 180 are formed by each of discharge cells in the PDP 100 illustrated in FIGS. 2 through 4. In another embodiment, the shield walls 180′ are formed by each of the discharge cells in the PDP illustrated in FIG. 5. Similar reference numerals in FIGS. 6 through 9 are used for like elements performing the same functions as those in FIGS. 2 through 5, and the detailed descriptions thereof are omitted.

Referring to FIGS. 6 through 8, the shield walls 280 are disposed surrounding each of the discharge cells in the PDP 200 according to the present embodiment, thereby more effectively preventing luminous interference between adjacent discharge cells.

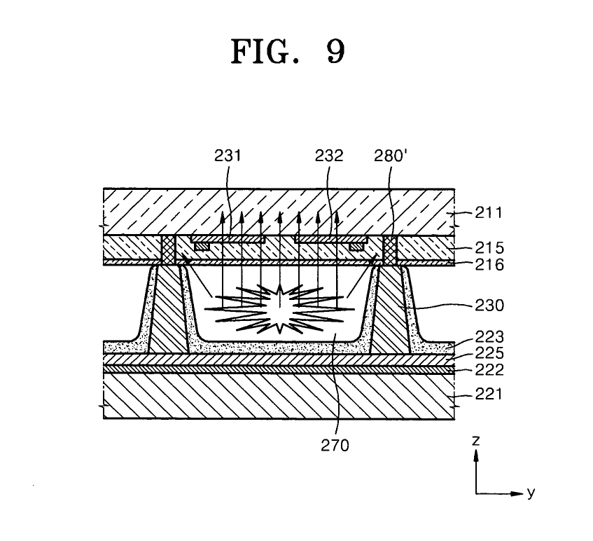

FIG. 9 is a cross-sectional view of the PDP according to a modified embodiment of FIG. 7. As shown in FIG. 9, the shield walls 280′ may be formed in a layer encompassing both the first dielectric layer 215 and the protective layer 216.

A PDP according to an embodiment of the present invention includes shield walls between each of the discharge cells, thereby preventing luminous interference between adjacent discharge cells.

The PDP also clearly divides luminous cells and non-luminous cells, thereby increasing the degree of definition of a displayed image.

While the present invention has been particularly shown and described with reference to exemplary embodiments thereof, it will be understood by those of ordinary skill in the art that various changes in form and details may be made therein without departing from the spirit and scope of the present invention as defined by the claims and their equivalents.

What is claimed is:

1. A plasma display panel comprising:
a first substrate and a second substrate facing each other;
barrier ribs disposed between the first substrate and the second substrate, the barrier ribs defining a plurality of discharge cells;
pairs of sustain electrodes extending in a direction on the first substrate and crossing the discharge cells;
address electrodes crossing the pairs of sustain electrodes;
a first dielectric layer covering the pairs of sustain electrodes;
a second dielectric layer covering the address electrodes;
phosphor layers formed in the discharge cells; and
shield walls disposed between the first substrate and the second substrate, the shield walls surrounding each of the discharge cells.

2. The plasma display panel of claim 1, wherein the shield walls are disposed between the first substrate and the barrier ribs.

3. The plasma display panel of claim 2, wherein the shield walls are formed on a same layer as the first dielectric layer.

4. The plasma display panel of claim 1, further comprising a protective layer covering a surface of the first dielectric layer to protect the first dielectric layer, the protective layer facing the second substrate, wherein the shield walls are formed in a layer encompassing both the first dielectric layer and the protective layer.

5. The plasma display panel of claim 1, wherein the shield walls are black.

6. The plasma display panel of claim 1, wherein the first dielectric layer is formed by a first dielectric layer material and the shield walls are formed by the first dielectric layer material with added black pigment.

7. The plasma display panel of claim 1, wherein the shield walls have a reflexibility of less than 60%.

8. A plasma display panel comprising:
a first substrate and a second substrate facing each other;
barrier ribs between the first substrate and the second substrate, the barrier ribs defining a plurality of discharge cells;
pairs of sustain electrodes extending in a direction on the first substrate and crossing the discharge cells;
address electrodes crossing the pairs of sustain electrodes;
a first dielectric layer covering the pairs of sustain electrodes;
a second dielectric layer covering the address electrodes;
phosphor layers formed in the discharge cells so as to provide pixels, each of the pixels having a red discharge cell, a green discharge cell, and a blue discharge cell adjacent to each other; and
shield walls disposed between the first substrate and the second substrate to surround each of the pixels.

9. The plasma display panel of claim 8, wherein the shield walls are disposed between the first substrate and the barrier ribs.

10. The plasma display panel of claim 9, wherein the shield walls are formed on a same layer as the first dielectric layer.

11. The plasma display panel of claim 8, further comprising a protective layer covering a surface of the first dielectric layer to protect the first dielectric layer, the protective layer facing the second substrate, wherein the shield walls are formed in a layer encompassing both the first dielectric layer and the protective layer.

12. The plasma display panel of claim 8, wherein the shield walls are black.

13. The plasma display panel of claim 8, wherein the first dielectric layer is formed by a first dielectric layer material and the shield walls are formed by the first dielectric layer material with added black pigment.

14. The plasma display panel of claim 8, wherein the shield walls have a reflexibility of less than 60%.

15. A method for preventing luminescence interference in a plasma display panel, the plasma display panel having a first substrate and a second substrate facing each other, barrier ribs disposed between the first substrate and the second substrate defining a plurality of discharge cells, pairs of sustain electrodes extending in a direction on the first substrate and crossing the discharge cells, address electrodes crossing the pairs of sustain electrodes, a first dielectric layer covering the pairs of sustain electrodes, a second dielectric layer covering the address electrodes, and phosphor layers formed in the discharge cells, the method comprising:
forming shield walls between the first substrate and the second substrate to surround one or more discharge cells so as to block light produced in the one or more discharge cells surrounded by the shield walls from causing luminescence interference with discharge cells outside the shield walls.

16. The method as claimed in claim 15, wherein the shield walls are formed between the first substrate and the barrier ribs.

17. The method as claimed in claim 16, wherein the shield walls are formed on a same layer as the first dielectric layer.

18. The method as claimed in claim 16, the method further comprising forming a protective layer covering a surface of the first dielectric layer to protect the first dielectric layer, the protective layer facing the second substrate, wherein the shield walls are formed in a layer encompassing both the first dielectric layer and the protective layer.

19. The method as claimed in claim 17, wherein the shield walls surround each of the discharge cells so as to block light produced in the each of the discharge cells from causing luminescence interference with adjacent discharge cells.

20. The method as claimed in claim 17, wherein the shield walls are black.
